(19) United States
(12) Patent Application Publication
(10) Pub. No.: US 2021/0229809 A1
(43) Pub. Date: Jul. 29, 2021

(54) POWER LINE INSPECTION METHOD AND APPARATUS, UNMANNED AERIAL VEHICLE, AND COMPUTER READABLE STORAGE MEDIUM

(71) Applicant: SZ DJI TECHNOLOGY CO., LTD., Shenzhen (CN)

(72) Inventor: Li QIU, Shenzhen (CN)

(21) Appl. No.: 17/229,838

(22) Filed: Apr. 13, 2021

Related U.S. Application Data
(63) Continuation of application No. PCT/CN2018/112203, filed on Oct. 26, 2018.

(51) Int. Cl. B64C 39/02; G01S 13/42; G01S 17/42; G01S 13/86; G01S 17/86

(52) U.S. Cl. CPC B64C 39/024; G01S 13/42; G01S 17/42; B64C 2201/141; G01S 17/86; B64C 2201/12; G01S 13/86

(57) ABSTRACT

A power line inspection method includes obtaining, by an unmanned aerial vehicle, relative distance information of a power line relative to a target, determining a to-be-adjusted position of the power line that needs to be adjusted according to the distance information, and sending information containing the to-be-adjusted position to a control terminal.

### CROSS-REFERENCE TO RELATED APPLICATION

This application is a continuation of International Application No. PCT/CN2018/112203, filed Oct. 26, 2018, the entire content of which is incorporated herein by reference.

### TECHNICAL FIELD

The present disclosure relates to the technical field of power inspection and, more particularly, to a power line inspection method and apparatus, unmanned aerial vehicle, and computer readable storage medium.

### BACKGROUND

Power resources are developing rapidly with the fast development of science and technology. While a power line is established, problem of trees that threaten the safe operation of lines under a power transmission line channel has become very prominent. When the trees grow within a safe distance of the power transmission line, a line trip failure may occur, threatening the safety and stability of the entire transmission network. Power tripping and outage caused by tree line contradiction will not only affect safe operation of the power grid and the interests of electric power enterprises, but more seriously, it will affect the safe and reliable power supply of the whole network and local economic development, and seriously threaten the safety of electricity supply and usage for enterprises, institutions, and residents.

Therefore, in order to ensure a safe, stable, and reliable operation of the power grid and create a good environment for economic and social development, it is of important practical significance to study a power line inspection method.

### SUMMARY

In accordance with the disclosure, there is provided a power line inspection method including obtaining, by an unmanned aerial vehicle, relative distance information of a power line relative to a target, determining a to-be-adjusted position of the power line that needs to be adjusted according to the relative distance information, and sending information containing the to-be-adjusted position to a control terminal.

Also in accordance with the disclosure, there is provided a power line inspection apparatus including a memory storing a computer program and a processor configured to execute the computer program to obtain relative distance information of a power line relative to a target, determine a to-be-adjusted position of the power line that needs to be adjusted according to the relative distance information, and send information containing the to-be-adjusted position to a control terminal.

Also in accordance with the disclosure, there is provided an unmanned aerial vehicle including a vehicle body and a power line inspection apparatus arranged at the vehicle body. The power line inspection apparatus includes a memory storing a computer program and a processor configured to execute the computer program to obtain relative distance information of a power line relative to a target, determine a to-be-adjusted position of the power line that needs to be adjusted according to the relative distance information, and send information containing the to-be-adjusted position to a control terminal.

### BRIEF DESCRIPTION OF THE DRAWINGS

FIG. 1 is a schematic flow chart of a power line inspection method according to an embodiment of the present disclosure.

FIG. 2 is a schematic flow chart of another power line inspection method according to an embodiment of the present disclosure.

FIG. 3 is a schematic diagram showing a positional relationship between an unmanned aerial vehicle and a power line according to an embodiment of the present disclosure.

FIG. 4 is a schematic flow chart of another power line inspection method according to an embodiment of the present disclosure.

FIG. 5 is a schematic diagram showing sag information of a power line according to an embodiment of the present disclosure.

FIG. 6 is a schematic diagram showing a chart output of distance information according to an embodiment of the present disclosure.

FIG. 7 is a schematic structural diagram of a power line inspection apparatus according to an embodiment of the present disclosure.

FIG. 8 is a schematic structural diagram of another power line inspection apparatus according to an embodiment of the present disclosure.

### DETAILED DESCRIPTION OF THE EMBODIMENTS

In order to make the objectives, technical solutions, and advantages of the embodiments of the present disclosure clearer, the technical solutions in the embodiments of the present disclosure will be clearly and completely described in combination with the accompanying drawings. Obviously, the described embodiments are some of rather than all the embodiments of the present disclosure. All other embodiments obtained by those of ordinary skill in the art based on the embodiments of the present disclosure without inventive effort shall fall within the scope of the present disclosure.

Unless otherwise defined, all technical and scientific terms used herein have the same meaning as commonly understood by those skilled in the technical field of the present disclosure. The terms used in the specification of the present disclosure herein are only for the purpose of describing specific embodiments, and are not intended to limit the present disclosure.

Some embodiments of the present disclosure will be described in detail with reference to the accompanying drawings. The following embodiments and the features in the embodiments may be combined with each other without conflict between embodiments.

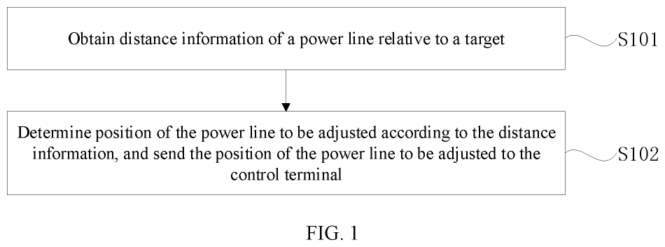

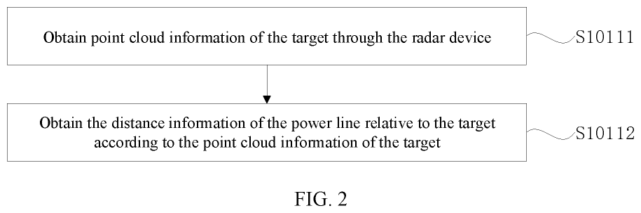

FIG. 1 is a schematic flow chart of a power line inspection method according to present disclosure. FIG. 2 is a schematic flow chart of another power line inspection method according to present disclosure. Referring to FIGS. 1 and 2, the present disclosure provides a power line inspection method, which can be implemented by an unmanned aerial vehicle coupled to a control terminal. In some embodiments, the method includes the following processes.

S101: Obtaining distance information of a power line relative to a target. The distance information of the power line relative to the target is also referred to as “relative distance information.”

The target includes at least one of the following: a tree barrier, a bridge, a tunnel, a highway, a railway, and another power line that differs from the power line, where the other power line may refer to an overhead transmission line. When the target is a tree barrier, the distance information of the power line relative to the target can refer to the distance information between the top of the tree barrier and the power line. When the target is another power line, the distance information of the power line relative to the target can refer to cross-span information between the power line and the other power line. When the target is a highway, railway, or another power line, the distance information of the power line relative to the target can refer to three-span information which, in some embodiments, can include the distance of the power line to the highway, the railway, or the other power line. When the target is a bridge, a tunnel, a tower, or another building supporting the power line, the distance information of the power line relative to the target can refer to sag information, pitch information, line length information, etc. of the power line when it passes through the target. It can be understood that these are merely examples. The type of the target may be another suitable type, and correspondingly the distance information of the power line relative to the target may also be other measurable distance information, which is not limited herein.

In addition, the present disclosure does not limit the way to obtain the distance information of the power line relative to the target. Those skilled in the art can set it according to specific design requirements. In some embodiments, obtaining the distance information of the power line relative to the target includes obtaining the distance information of the power line relative to the target through a sensor provided at the unmanned aerial vehicle.

The sensor may be a radar device, and in some embodiments, the radar device may be a microwave radar or a laser radar. That is, the distance information of the power line relative to the target can be obtained by a radar device. The radar device may be arranged on top of the unmanned aerial vehicle to ensure that the detection field angle of the radar device is not blocked, thereby improving the accuracy and reliability of the radar device detection. Of course, those skilled in the art can also arrange the radar device at another position such as the front end, bottom end, or side end of the unmanned aerial vehicle according to specific design requirements.

In some embodiments, as shown in FIG. 2, obtaining the distance information of the power line relative to the target through the sensor includes obtaining point cloud information of the target through the radar device (S10111) and obtaining the distance information of the power line relative to the target according to the point cloud information of the target (S10112).

In some embodiments, the radar device is configured to scan a target space where the target and the power line are located to obtain scanned data which may include information such as pitch angle of the unmanned aerial vehicle relative to the target, and direction of the unmanned aerial vehicle relative to the target. Then the scanned data is processed to obtain the corresponding point cloud data. Further, after the point cloud data is obtained, it can be corrected by combining with detection data from another detection device, such as attitude data of the unmanned aerial vehicle obtained by an inertial measurement unit (IMU), to improve the display quality and effect of an image.

In addition, the present disclosure does not limit the specific arrangement position of the radar device when the point cloud information of the target is obtained through the radar device. Those skilled in the art can arrange the radar device according to specific design requirements. For example, the radar device can be arranged at the front end, top end, bottom end, or side end of the unmanned aerial vehicle, as long as the detection field angle of the radar device is not blocked and the accuracy and reliability of obtaining the point cloud information of the target is ensured.

After the point cloud data of the target is obtained, the distance information of the power line relative to the target can be determined by analyzing and processing the point cloud data.

In one embodiment, the radar device may be a laser radar. The laser radar emits a laser beam from a laser emitter, where the speed of the laser beam in the air is a constant value of the light speed c. The distance of the target is calculated from the round-trip time of the laser beam traveling between the laser radar and the target. Assuming that the distance between the laser radar and the target is d, and the elapsed time of the laser beam traveling to and from the target is t, then the distance between the laser radar and the target is d=ct/2. Further, the laser radar can obtain a three-dimensional distance information between the power line and the target through 360-degree scanning.

In another embodiment, the radar device may be a microwave radar, which may be fixed, for example, at the side end of the unmanned aerial vehicle. It is understandable that those skilled in the art can also set the microwave radar at another suitable position based on specific design requirements and conditions, such as any suitable position where the detection field angle of the radar device is not blocked. In some embodiments, the microwave radar may be a millimeter wave radar or a centimeter wave radar.

Further, the microwave radar can be mounted at the unmanned aerial vehicle via a rotation shaft, and the microwave radar can rotate around the rotation shaft. The microwave radar can perform horizontal rotation around the rotation shaft (the rotation shaft can be regarded as perpendicular to the ground at this time), or the microwave radar can perform vertical rotation (the rotation shaft can be regarded as parallel to the ground at this time). Further, during the continuous rotation of the microwave radar, it can obtain the distance information of the power line relative to the target in real time, generate corresponding point cloud information, and then feed back the point cloud information to the control terminal. In another embodiment, the microwave radar can also detect information such as distance, speed, direction, height of the unmanned aerial vehicle relative to the target.

It is understandable that the radar device provided at the unmanned aerial vehicle can also include laser radar and microwave radar. In another embodiment, those skilled in the art can also use another method to obtain the distance information of the power line relative to the target as long as the accuracy and reliability of obtaining the distance information of the power line relative to the target can be ensured. For example, the three-dimensional coordinate points of the target can be obtained by the radar device, and the three-dimensional coordinate points of the power line can be obtained by the radar device. The distance of the power line relative to the target can be determined from the three-dimensional coordinate points of the target and the three-dimensional coordinate points of the power line.

In the present disclosure, the distance information of the power line relative to the target can be obtained by the radar device. The measurement accuracy is high, and the processing speed is fast. The distance information obtained by the radar device can be sent to a flight control system of the unmanned aerial vehicle in real time, to obtain relevant information about the power line in time. In addition, the microwave radar will not be affected by environmental conditions such as rain, dust, smoke, fog or frost, and can work in complete darkness or under direct sunlight, with high reliability and stability.

Referring again to FIG. 1, at S102, a position of the power line that needs to be adjusted is determined according to the distance information, and the position of the power line that needs to be adjusted is sent to the control terminal. The position of the power line that needs to be adjusted is also referred to as a “to-be-adjusted position” of the power line.

After the distance information is obtained, it can be analyzed and processed, and the power line that needs to be adjusted can be determined based on the analysis and processing results. Further, the position of the power line that needs to be adjusted can be obtained by a positioning device such as a global positioning system (GPS) device or a real-time kinematic (RTK) positioning device. After the position of the power line that needs to be adjusted is determined, it can be sent to the control terminal, so that a user can directly obtain the position of the power line that needs to be adjusted through the control terminal, to effectively adjust the position of the power line in time.

It is understandable that the position information of the power lines around the unmanned aerial vehicle can also be obtained in real time using a positioning device such as a GPS device or an RTK device. The position information can be combined with the distance information of the power line relative to the unmanned aerial vehicle to generate, e.g., a longitude-latitude-elevation map, so that users can directly observe and find the position of the power line that needs to be adjusted in real time, to effectively adjust the position of the power line in time.

The power line inspection method provided in the present disclosure can obtain the distance information of the power line relative to the target in real time. Further, the method can determine the power line position to be adjusted based on the distance information, and then send the power line position to be adjusted to the control terminal. This allows users to adjust power lines in time, thereby improving the quality and efficiency of power line inspection, and further ensuring a safe, stable, and reliable operation of the power grid. The present method creates a good environment for economic and social development, which further improves the practicability of the method and is conducive to market promotion and application.

As shown in FIGS. 1 and 2 and described above, the method consistent with the present disclosure is based on the distance information of the power line relative to the target obtained by the unmanned aerial vehicle. Therefore, in order to ensure a safe and reliable operation of the unmanned aerial vehicle, the method in the present disclosure further includes controlling the unmanned aerial vehicle to fly along the power line before obtaining the distance information of the power line relative to the target.

In some embodiments, controlling the unmanned aerial vehicle to fly along the power line may include controlling the unmanned aerial vehicle to fly at a preset distance from the power line.

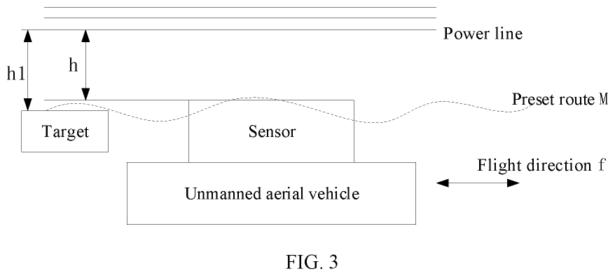

The preset distance can be distance information that is pre-set, and the specific value of the preset distance is not limited in the present disclosure. Those skilled in the art can set the preset distance according to specific requirements. As shown in FIG. 3, the unmanned aerial vehicle keeps a preset distance of h meters from the power line, where h meters can be, for example, 1 m, 2 m, 3 m, 5 m, etc. It should be noted that the stability of the distance between the unmanned aerial vehicle and the power line needs to be ensured when controlling the unmanned aerial vehicle to fly at the preset distance from the power line, to prevent the unmanned aerial vehicle from being interfered by the power line and ensure the flight safety of the unmanned aerial vehicle.

In some embodiments, controlling the unmanned aerial vehicle to fly along the power line can include controlling the unmanned aerial vehicle to fly along the power line according to a preset route.

That is, when the unmanned aerial vehicle is controlled to fly along the power line, a preset route can be generated based on the power line in advance. In some embodiments, considering the stability and reliability of flight of the unmanned aerial vehicle, the unmanned aerial vehicle needs to avoid the target and fly along the power line. Therefore, the preset route can be generated based on the obtained position of the power line and the target, as well as the status of the unmanned aerial vehicle. As shown in FIG. 3, a preset route M is obtained, and the unmanned aerial vehicle is then controlled to fly along the power line according to the preset route M, so that not only the safety and reliability of the flight of the unmanned aerial vehicle are ensured but also the distance information of the power line relative to the target is obtained.

In some embodiments, controlling the unmanned aerial vehicle to fly along the power line may include controlling the unmanned aerial vehicle to fly along a tangent direction of the power line.

The tangent direction of the power line can be a tangent direction parallel to the power line. As shown in FIG. 3, the arrangement direction of the power line is horizontal direction. In this scenario, the tangent direction of the power line includes a tangent direction parallel to the transmission direction of the power line, a tangent direction perpendicular to the transmission direction of the power line, a tangent direction that forms a preset acute angle with the power line transmission direction, and/or a tangent direction that forms a preset obtuse angle with the power line transmission direction. In some embodiments, taking the power line with a cylindrical structure as an example, a characteristic line segment of the power line at the bottom of the cylinder is obtained, and all tangent lines passing through the characteristic line segment are obtained. These tangent lines form a tangent plane, which includes a first tangent line, a second tangent line, a third tangent line, etc. that are tangent to the characteristic line segment. The extension direction of the first tangent line may be parallel to the extension direction of the characteristic line segment, the extension direction of the second tangent line may form a preset acute or obtuse angle with the extension direction of the characteristic line segment, and the extension direction of the third tangent line may be perpendicular to the extension direction of the characteristic line segment. In order to realize fault detection of the power line, in some embodiments the unmanned aerial vehicle is controlled to fly in the tangent direction parallel to the transmission direction of the power line, i.e., the unmanned aerial vehicle is controlled to fly along the direction of the first tangent line. In the example shown in FIG. 3, the direction of the first tangent line is direction f In this way, problems of a manual inspection on the power line in existing technologies, which are not only dangerous, time-consuming, labor-consuming, but also with low inspection quality and accuracy, can be overcome, and the practicability of the present method is further improved.

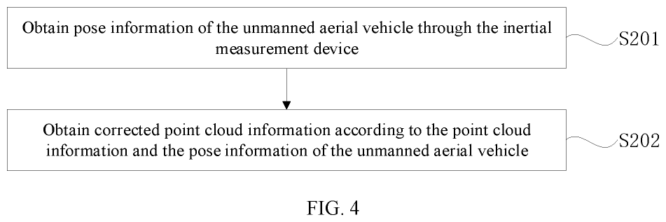

FIG. 4 is a schematic flow chart of another power line inspection method provided by the present disclosure. In some embodiments, the unmanned aerial vehicle in the present disclosure also includes an inertial measurement device. The example method shown in FIG. 4 is based on the example methods described above. As shown in FIG. 4, the method further includes, after the point cloud information of the target is obtained by the radar device, obtaining pose information of the unmanned aerial vehicle through the inertial measurement device (S201) and obtaining corrected point cloud information according to the point cloud information and the pose information of the unmanned aerial vehicle (S202).

The pose information of the unmanned aerial vehicle refers to position information and attitude information of the unmanned aerial vehicle in a designated coordinate system. The attitude information can include angular velocity and acceleration, etc. of the unmanned aerial vehicle. The pose information of the unmanned aerial vehicle can be accurately obtained through the inertial measurement device provided at the unmanned aerial vehicle.

The obtained point cloud information can be corrected based on the pose information of the unmanned aerial vehicle, so that the corrected point cloud information can be obtained. The present disclosure does not limit the specific implementation process of obtaining the corrected point cloud information according to the point cloud information and the pose information of the unmanned aerial vehicle. Those skilled in the art can set it according to specific design requirements. For example, the obtained point cloud information can be corrected based on the pose information and time information, so that the corrected point cloud information can be obtained to improve the accuracy of the point cloud information. Of course, those skilled in the art can also use other methods to obtain the corrected point cloud information. For example, a preset correction parameter corresponding to the pose information can be determined and then used to correct the point cloud information, and the description will not be repeated herein.

The distance information of the power line relative to the target can be obtained based on the corrected point cloud information after it is obtained, thereby effectively ensuring the accuracy of determining the distance information of the power line relative to the target.

In some embodiments, obtaining the distance information of the power line relative to the target can include obtaining first distance information, and the first distance information includes linear distance information between the power line and the target. Further, the linear distance information may be vertical distance information between the power line and the target. In this case, the target may include a tree barrier. Further, obtaining the distance information of the power line relative to the target may include obtaining the first distance information between the top of the tree barrier and the power line through the sensor. When the power line includes multiple power lines arranged at intervals in vertical direction, the first distance information is the distance between the lowest power line and the top of the tree barrier, to ensure the flight safety of the unmanned aerial vehicle.

In some embodiments, as shown in FIG. 3, when the target is a tree barrier, the power lines are set at the upper end of the tree barrier. Therefore, when obtaining the distance information of the power line relative to the target, the sensor can be used to obtain the first distance information hl between the top of the tree barrier and bottom power line, where the bottom power line is the lowest power line among the power lines.

In some other embodiments, obtaining the distance information of the power line relative to the target may include obtaining second distance information, and the second distance information includes at least one of cross-span information or three-span information. In this case, the target includes at least one of the following: a highway, a railway, and another power line that differ from the power line. Further, obtaining the distance information of the power line relative to the target may include obtaining the second distance information of the power line relative to the target through the sensor.

The second distance information can include at least one of cross-span information or three-span information. That is, cross-span information and/or three-span information of the power line relative to the target can be obtained. The cross-span information refers to the power line crossing over or under another power line. In this case, vertical distance between the upper and lower power lines is the cross-span information. The three-span information refers to the distance between the power line and the railway contact network, the distance between the power line and the highway, or the distance between the power line and the other power line, when the power line crosses the railway, the highway, or the other power line. The other power line can be, e.g., an overhead transmission line segment of an important power transmission channel.

In some other embodiments, obtaining the distance information of the power line relative to the target may include obtaining third distance information, and the third distance information includes at least one of the following: sag information, pitch information, and line length information. In this case, the target may include at least one of the following: a bridge, a tunnel, a tower, and another building supporting the power line. Further, obtaining the distance information of the power line relative to the target may include obtaining the third distance information of the power line through the sensor when the power line traverses/crosses the target.

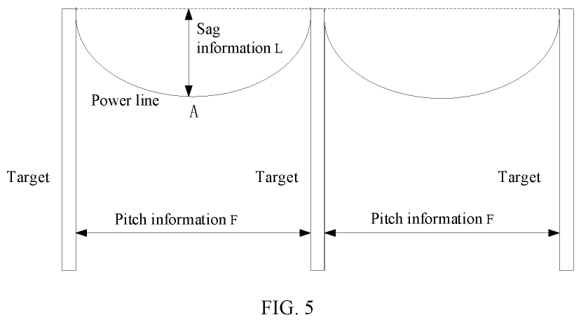

The third distance information includes at least one of the following: sag information, pitch information, line length information. That is, when the power line traverses, crosses, or is arranged at the target, the sag information, the pitch information, and/or the line length information of the power line can be obtained through the sensor. The sag information refers to sag of a certain point on the power line, which, in some embodiments, refers to the vertical distance from two suspension points to the certain point of the power line. As shown in FIG. 5, the targets are towers, and a power line is arranged between two towers, and the power line forms a certain arc between the two towers. In this case, for point A on the power line, the sag of point A is the vertical distance from the power line to this point, i.e., sag information L. In addition, the pitch information described above refers to horizontal distance between two suspension points of the power line in a plane parallel to load on the power line between two adjacent targets. As shown in FIG. 5, when the targets are towers, the horizontal distance between the suspension points of two adjacent towers is pitch information F. Furthermore, other suitable power line information such as line length information can be obtained by calculation as needed, and the description will not be repeated herein.

It can be seen that in different application scenarios, different distance information of the power line relative to the target can be obtained, thereby effectively expanding the application scope of the power line inspection and ensuring flexible practicability of the present method, which also improves the practicability of the method.

Further, the present disclosure does not limit the specific implementation mode of determining the position of the power line that needs to be adjusted according to the distance information. Those skilled in the art can set it according to specific design requirements. In some embodiments, determining the position of the power line that needs to be adjusted according to the distance information can include, when the distance information is less than a preset distance threshold, the power line position corresponding to the distance information is determined as the power line position that needs to be adjusted. In this disclosure, comparing the distance information with a value can refer to comparing a distance indicated by the distance information with the value.

The distance threshold is preset distance information. The present disclosure does not limit the specific value of the distance threshold. Those skilled in the art can set it according to specific setting requirements. For example, the distance threshold may be 1 m, 2 m, 3 m, 5 m, etc. In addition, after the distance information of the power line relative to the target is obtained, it can be analyzed and processed based on the preset distance threshold. When the distance information is less than the preset distance threshold, it means that the arrangement of the power line is not proper. In this scenario, the arrangement of the power line relative to the target is likely to increase the probability of a power line failure or increase the risk in using the power line. Therefore, the power line position corresponding to the distance information can be determined as the power line position that needs to be adjusted.

In some embodiments, the method consistent with the disclosure further includes, after determining the power line position that needs to be adjusted according to the distance information, generating an alarm signal and sending it to the control terminal, where the alarm signal can indicate the need to increase the distance information of the power line relative to the target at the power line position that needs to be adjusted.

In order to avoid increasing the probability of power line failure or the degree of danger in power line usage, an alarm signal can be generated and sent to the control terminal. The alarm signal can be an audio and visual alarm signal, an audio alarm signal, a light-emitting alarm signal, and an information alarm signal, etc. The alarm signal includes information indicating the need to increase the distance information of the power line relative to the target at the power line position that needs to be adjusted, so that the arrangement of the power line relative to the target conforms to the specification, thereby ensuring the safety and reliability of using the power line.

In some embodiments, the method in the present disclosure may further include, when the distance information is greater than the preset distance threshold, the power line position corresponding to the distance information is determined as the power line position that needs to be adjusted.

After the distance information of the power line relative to the target is obtained, it can be analyzed and processed based on the preset distance threshold. When the distance information is greater than the preset distance threshold, it means that the arrangement of the power line is not proper. In this scenario, the arrangement of the power line relative to the target is likely to affect the working efficiency and quality of the power line, and may cause redundant setting of the power line, which increases the design cost. Therefore, the power line position corresponding to the distance information can be determined as the power line position that needs to be adjusted.

In some embodiments, the method consistent with the disclosure further includes, after determining the power line position that needs to be adjusted according to the distance information, generating an alarm signal and sending it to the control terminal, where the alarm signal can indicate the need to reduce the distance information of the power line relative to the target at the power line position that needs to be adjusted.

In order to avoid affecting the working efficiency and quality of the power line, possibly causing redundant setting of the power line, and increasing the design cost, the alarm signal can be generated and sent to the control terminal. The alarm signal can include information indicating the need to reduce the distance information of the power line relative to the target at the power line position that needs to be adjusted, so that the arrangement of the power line relative to the target conforms to the specification, thereby ensuring the working quality and efficiency of the power line and also reducing costs.

In some embodiments, the method consistent with the disclosure further includes, after the distance information of the power line relative to the target is obtained, outputting the distance information and the power line position in a preset manner which includes at least one of the following: a text mode, a graphic mode, and a chart mode.

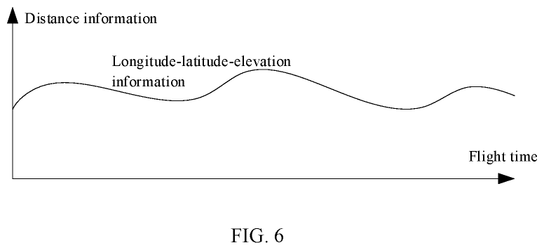

In some embodiments, as shown in FIG. 6, a chart including distance information and longitude-latitude-elevation information of the power line position is provided in a chart mode. The chart further includes time information. In some embodiments, the radar device continuously scans the target without interruption and performs distance measurement simultaneously, to generate a chart in real time that contains mapping relationship between the distance information of the power line relative to the target, the position information, and the flight time, so that it is convenient for users to view directly. For example, when the unmanned aerial vehicle is flying along the power line, the sensor can detect the distance information of the power line relative to the target (such as top of a tree) in real time. Further, coordinate position of the unmanned aerial vehicle can be obtained at the same time, and coordinate position of the point cloud information can be calculated according to the coordinate position of the unmanned aerial vehicle and the point cloud information, so that landform undulation information containing the distance and position information of multiple targets can be obtained and output in the chart mode. The position information of the unmanned aerial vehicle, which can be obtained through a GPS device or an RTK device, combined with the distance information between the power line and the target, is beneficial for workers to locate the problematic power line position in time.

With the chart that contains distance information, position information, and time information in the preset manner, users can directly check the arrangement status of the power line relative to the target, so as to conveniently understand the inspection results of the power line. Users can also perform timely adjustment, modification, or optimization to the power line based on the inspection results, which further improves the practicability of the present method.

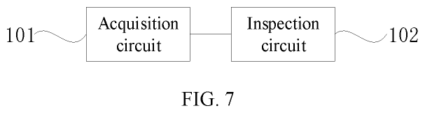

FIG. 7 is a schematic structural diagram of a power line inspection apparatus according to present disclosure. The power line inspection apparatus shown in FIG. 7 can be applied to an unmanned aerial vehicle coupled to a control terminal. As shown in FIG. 7, the inspection apparatus includes an acquisition circuit 101 and an inspection circuit 102.

The acquisition circuit 101 is configured to obtain distance information of a power line relative to a target.

The inspection circuit 102 is configured to determine position of the power line that needs to be adjusted according to the distance information, and send the position of the power line that needs to be adjusted to the control terminal.

The acquisition circuit 101 and the inspection circuit 102 of the power line inspection apparatus provided in the present disclosure can be configured to execute a power line inspection method consistent with the disclosure, such as one of the example methods described above in connection with FIGS. 1-6. The specific execution way and beneficial effect thereof are similar, and will not be repeated herein.

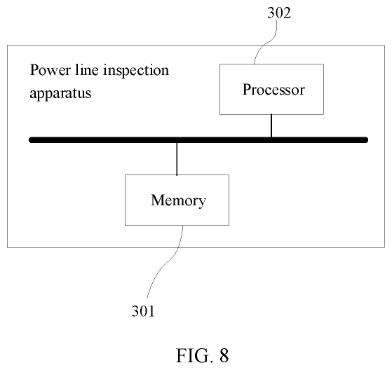

FIG. 8 is schematic structural diagram of another power line inspection apparatus according to the present disclosure. The example inspection apparatus shown in FIG. 8 can be applied to an unmanned aerial vehicle coupled to a control terminal. As shown in FIG. 8, the inspection apparatus includes a memory 301 and a processor 302.

The memory 301 is configured to store a computer program.

The processor 302 is configured to run the computer program stored in the memory 301 to obtain distance information of a power line relative to a target, determine position of the power line to be adjusted according to the distance information, and send the position of the power line to be adjusted to the control terminal.

In some embodiments, the processor 302 is further configured to, before obtaining the distance information of the power line relative to the target, control the unmanned aerial vehicle to fly along the power line.

In some embodiments, the processor 302 is further configured to, when controlling the unmanned aerial vehicle to fly along the power line, control the unmanned aerial vehicle to fly at a preset distance from the power line, or control the unmanned aerial vehicle to fly along the power line according to a preset route, or control the unmanned aerial vehicle to fly along a tangent direction of the power line.

In some embodiments, the processor 302 is further configured to, when obtaining the distance information of the power line relative to the target, obtain the distance information of the power line relative to the target through a sensor which is provided at the unmanned aerial vehicle.

In some embodiments, the sensor is a radar device which may include a microwave radar and/or a laser radar. Also, the radar device can be mounted at top of the unmanned aerial vehicle.

In some embodiments, the processor 302 is further configured to, when obtaining the distance information of the power line relative to the target through the sensor, obtain point cloud information of the target through the radar device, and obtain the distance information of the power line relative to the target according to the point cloud information of the target.

In some embodiments, the unmanned aerial vehicle also includes an inertial measurement device. The processor 302 is further configured to, after obtaining the point cloud information of the target through the radar device, obtain pose information of the unmanned aerial vehicle through the inertial measurement device and obtain corrected point cloud information according to the point cloud information and the pose information of the unmanned aerial vehicle.

In some embodiments, the distance information may include first distance information, and the first distance information includes linear distance information between the power line and the target. Further, the linear distance information may be vertical distance information between the power line and the target. In this case, the target may include a tree barrier. The processor 302 is further configured to, when obtaining the distance information of the power line relative to the target, obtain the first distance information between top of the tree barrier and bottom power line through the sensor, where the bottom power line is the lowest power line among the power lines.

In some embodiments, the distance information may include second distance information, and the second distance information includes at least one of cross-span information or three-span information. In this case, the target includes at least one of the following: a highway, a railway, and another power line that differs from the power line. The processor 302 is further configured to, when obtaining the distance information of the power line relative to the target, obtain the second distance information of the power line relative to the target through the sensor.

In some embodiments, the distance information may include third distance information, and the third distance information includes at least one of the following: sag information, pitch information, and line length information. In this case, the target may include at least one of the following: a bridge, a tunnel, a tower, and another building supporting the power line. The processor 302 is further configured to, when obtaining the distance information of the power line relative to the target, obtain the third distance information of the power line through the sensor when the power line traverses/crosses the target.

In some embodiments, the processor 302 is further configured to, when determining the power line position that needs to be adjusted according to the distance information, determine the power line position corresponding to the relative distance information as the to-be-adjusted position in response to a distance indicated by the relative distance information being less than a preset distance threshold,.

In some embodiments, the processor 302 is further configured to, after determining the position of the power line that needs to be adjusted according to the distance information, generate an alarm signal and send it to the control terminal. The alarm signal includes information indicating the need to increase the distance information of the power line relative to the target at the power line position that needs to be adjusted.

In some embodiments, the processor 302 is further configured to, after obtaining the distance information of the power line relative to the target, output the distance information and the power line position in a preset manner. The preset manner includes at least one of the following: a text mode, a graphic mode, and a chart mode.

The power line inspection apparatus provided in the present disclosure can be configured to execute a power line inspection method consistent with the disclosure, such as one of the example methods described above in connection with FIGS. 1-6. The specific execution way and beneficial effect thereof are similar, and will not be repeated herein.

The present disclosure also provides an unmanned aerial vehicle, which includes a vehicle body and a power line inspection apparatus consistent with the disclosure described above, and the power line inspection apparatus is arranged at the vehicle body.

The present disclosure also provides a computer readable storage medium which stores program instructions, and the program instructions, when executed, can implement a power line inspection method consistent with the disclosure, such as one of the example methods described above in connection with FIGS. 1-6.

The technical solutions and technical features in various embodiments described above can be implemented individually or be combined when there is no conflict, and all such belong to the equivalent embodiments within the scope of the present disclosure as long as they do not exceed the cognitive range of those skilled in the art.

The disclosed apparatus and method can be implemented in other manners. For example, the example apparatus described above is only illustrative. For example, the division of the modules or units is only a logical function division, and there may be other divisions in actual implementation, e.g., multiple units or components may be combined or integrated into another system, or some features may be omitted or not performed. In addition, the displayed or discussed mutual coupling or direct coupling or communication connection may be through some interfaces, and indirect coupling or communication connection of the apparatus or unit may be in electrical, mechanical, or another form.

The units described as separate components may or may not be physically separated, and the components displayed as units may or may not be physical units, i.e., they may be located in one place, or distributed on multiple network units. Some or all of the units may be selected according to actual needs to achieve the objectives of the present disclosure.

In addition, the functional units in each embodiment of the present disclosure may be integrated into one processing unit, or each unit may exist alone physically, or two or more units may be integrated into one unit. The integrated unit herein can be implemented in the form of hardware or software functional unit.

If the integrated unit is implemented in the form of a software functional unit and sold or used as an independent product, it can be stored in a computer readable storage medium. Based on such an understanding, the technical solution of the present disclosure essentially, or in other words, all or part of the technical solution can be embodied in the form of a software product. The computer software product is stored in a storage medium, including several instructions to cause a computer processor (processor) to execute a method consistent with the present disclosure or part thereof, such as one of the above-described example methods. The storage medium described above can include a USB disk, a mobile hard disk, a read-only memory (ROM), a random access memory (RAM), a magnetic disk, an optical disks, or another medium that can store program codes.

Described above are only some embodiments of the present disclosure and do not limit the scope of the present disclosure. Any equivalent structure or equivalent process transformation made by using the content of the specification and drawings of the present disclosure, or directly or indirectly implementation on other related technical fields, are all included in the scope of patent protection of the present disclosure.

Finally, it should be noted that the embodiments described above are only used to illustrate the technical solutions of the present disclosure rather than limiting them. Although the present disclosure has been described in detail with reference to all the described embodiments, those of ordinary skill in the art should understand that the technical solutions in all the described embodiments can still be modified, or some or all of the technical features can be equivalently replaced. The modifications or replacements do not cause the essence of the corresponding technical solutions to depart from the scope of the technical solutions in the embodiments of the present disclosure.

What is claimed is:

1. A power line inspection method comprising:
obtaining, by an unmanned aerial vehicle, relative distance information of a power line relative to a target;
determining a to-be-adjusted position of the power line that needs to be adjusted according to the relative distance information; and
sending information containing the to-be-adjusted position to a control terminal.

2. The method of claim 1, further comprising, before obtaining the relative distance information:
controlling the unmanned aerial vehicle to fly along the power line.

3. The method of claim 2, wherein controlling the unmanned aerial vehicle to fly along the power line includes:
controlling the unmanned aerial vehicle to fly at a preset distance from the power line;
controlling the unmanned aerial vehicle to fly along the power line according to a preset route; or
controlling the unmanned aerial vehicle to fly along a tangent direction of the power line.

4. The method of claim 1, wherein obtaining the relative distance information includes obtaining the relative distance information through a sensor provided at the unmanned aerial vehicle.

5. The method of claim 4, wherein:
the sensor is a radar device; and
obtaining the relative distance information through the sensor includes:
obtaining point cloud information of the target through the radar device; and
obtaining the relative distance information according to the point cloud information.

6. The method of claim 5, wherein the radar device includes at least one of a microwave radar or a laser radar.

7. The method of claim 5, wherein the radar device is mounted at a top of the unmanned aerial vehicle.

8. The method of claim 5,
wherein the unmanned aerial vehicle further includes an inertial measurement device;
the method further comprising:
obtaining pose information of the unmanned aerial vehicle through the inertial measurement device; and
obtaining corrected point cloud information according to the point cloud information and the pose information of the unmanned aerial vehicle.

9. The method of claim 1, wherein the relative distance information includes linear distance information between the power line and the target.

10. The method of claim 9, wherein:
the target includes a tree barrier;
the power line is one of a plurality of power lines; and
obtaining the relative distance information includes obtaining the linear distance information between a top of the tree barrier and a lowest one of the plurality of power lines through a sensor.

11. The method of claim 1, wherein the relative distance information includes at least one of cross-span information or three-span information.

12. The method of claim 11, wherein:
the target includes at least one of a highway, a railway, or another power line that differs from the power line; and
obtaining the relative distance information includes obtaining the at least one of the cross-span information or the three-span information of the power line relative to the target through a sensor.

13. The method of claim 1, wherein the relative distance information includes at least one of sag information, pitch information, or line length information.

14. The method of claim 13, wherein:
the target includes at least one of a bridge, a tunnel, a tower, or a building supporting the power line; and
obtaining the relative distance information includes obtaining the at least one of the sag information, the pitch information or the line length information of the power line relative to the target through a sensor.

15. The method of claim 1, wherein determining the to-be-adjusted position includes determining a power line position corresponding to the relative distance information as the to-be-adjusted position in response to a distance indicated by the relative distance information being less than a preset distance threshold.

16. The method of claim 15, further comprising, after determining the to-be-adjusted position:
generating an alarm signal and sending the alarm signal to the control terminal, the alarm signal indicating a need to increase the distance.

17. The method of claim 1, further comprising, after determining the to-be-adjusted position:
outputting the relative distance information and the to-be-adjusted position in a preset manner, the preset manner including at least one of a text mode, a graphic mode, or a chart mode.

18. A power line inspection apparatus comprising:
a memory storing a computer program; and
a processor configured to execute the computer program to:
obtain relative distance information of a power line relative to a target;
determine a to-be-adjusted position of the power line that needs to be adjusted according to the relative distance information; and
send information containing the to-be-adjusted position to a control terminal.

19. The apparatus of claim 18, where the processor is further configured to, before obtaining the relative distance information, control an unmanned aerial vehicle carrying the power line inspection apparatus to fly along the power line.

20. An unmanned aerial vehicle comprising:
a vehicle body; and
a power line inspection apparatus arranged at the vehicle body and including:
a memory storing a computer program; and
a processor configured to execute the computer program to:
obtain relative distance information of a power line relative to a target;
determine a to-be-adjusted position of the power line that needs to be adjusted according to the relative distance information; and
send information containing the to-be-adjusted position to a control terminal.
